(19) United States
(12) Patent Application Publication
(10) Pub. No.: US 2017/0357255 A1
(43) Pub. Date: Dec. 14, 2017

(54) METHOD FOR CONTROLLING UNMANNED AERIAL VEHICLE USING SMART DEVICE

(71) Applicant: Shenzhen Hubsan Technology Co., Ltd., Shenzhen (CN)

(72) Inventors: GuangJun Li, Shenzhen (CN); XiaoJian Wan, Shenzhen (CN)

(21) Appl. No.: 15/216,930

(22) Filed: Jul. 22, 2016

(30) Foreign Application Priority Data
Jun. 11, 2016 (CN) 201610401699.1

(51) Int. Cl. G05D 1/00; B64C 39/02; G05D 1/04

(52) U.S. Cl. CPC G05D 1/0016; G05D 1/0038; G05D 1/042; B64C 39/024; G05D 1/0022; B64C 2201/146

(57) ABSTRACT

A method for controlling unmanned aerial vehicle using a smart device. The unmanned aerial vehicle includes a smart device and an unmanned plane, the smart device operating to control the flight of the unmanned plane via wireless communication signal, the smart device comprising in-built central processing unit, touch screen, wireless communication system, battery, and volume key, and an application for controlling the unmanned plane being installed in the smart device. The unmanned plane includes a power system, a flight control system, and a sensor. The method includes: 1) allowing the wireless communication system of the smart device to communicate with the unmanned plane; 2) allowing the application installed in the smart device to manipulate the unmanned plane; 3) allowing the wireless communication system to control the transmission of the commands of the unmanned plane, and to send the flight parameters of the unmanned plane back to the smart device; and 4) defining the volume key of the smart device to synchronously adjust the flight height of the unmanned plane. The volume key of the smart device is defined to synchronously adjust the flight height of the unmanned plane, so that the height of the unmanned plane is controlled conveniently.

### FIELD OF THE INVENTION

The invention relates to the field of unmanned aerial vehicle, and more particularly to a method for controlling unmanned aerial vehicle using a smart device.

### BACKGROUND OF THE INVENTION

Unmanned aerial vehicle (UAV) is an unmanned aircraft which is controlled by radio remote equipment and an autonomous program control device, including unmanned helicopters, fixed-wing aircrafts, multi-rotor crafts, unmanned airship, and unmanned parawings. More broadly, UAV also includes near space vehicles (NSV) (airspace of 20-100 km), such as stratospheric airship, aerostats, unmanned solar-powered drones. To some extent, UAV can perform complex air flight and various kinds of load missions, so it is regarded as an aerial robot.

### SUMMARY OF THE INVENTION

In view of the above-described problems, it is one objective of the invention to provide a method for controlling unmanned aerial vehicle using a smart device. The height of the unmanned aerial vehicle is synchronously controlled by a volume key thereof.

To achieve the above objective, in accordance with one embodiment of the invention, there is provided a method for controlling an unmanned aerial vehicle using a smart device, wherein the unmanned aerial vehicle comprises at least a smart device and an unmanned plane, wherein the smart device is configured to operate to control the flight of the unmanned plane via wireless communication signals, wherein the smart device comprises an in-built central processing unit, a touch screen, a wireless communication system, a battery, a volume key, and an application for controlling the unmanned plane being installed with the smart device; wherein the unmanned plane comprises a power system, a flight control system, and a sensor; wherein an operation interface of the application is configured to display information returned from the unmanned plane via communication link, and control signals being transmitted to the unmanned plane via the communication link through inputting operational commands; wherein the operational commands sent to the unmanned plane comprises flight in fixed height, automatic flight, manual flight, direction control of the unmanned plane, height adjustment, one-key take off, photographing and video; wherein the application comprises a virtual accelerator and yawer, and a virtual rolling and pitching rocker; wherein the smart device is configured to display shot images and geographical images taken by the unmanned plane, flight parameters and sensor information of the unmanned plane; wherein the displayed information comprises compass information, wifi/Bluetooth/3G/4G/5G signals, GPS signals, battery indicator, flight time, flight speed, flight height, and flight distance; wherein the volume key of the smart device is configured to operate to synchronously adjust the flight height of the unmanned plane, increasing the height by turning up the volume, decreasing the height by turning down the volume.

According to an embodiment, the method for controlling unmanned aerial vehicle comprises: 1) using the wireless communication system of the smart device to communicate with the unmanned plane; 2) using the application installed in the smart device to manipulate the unmanned plane; 3) using the wireless communication system to control the transmission of the commands of the unmanned plane, and to send the flight parameters of the unmanned plane back to the smart device; and 4) defining the volume key of the smart device to synchronously adjust the flight height of the unmanned plane.

According to an embodiment, the sensor comprises GPS, barometer, gyro, accelerometer, and compass.

According to an embodiment, the wireless communication system comprises 3G, 4G, 5G, Bluetooth, and wifi communications.

Advantages of the method for controlling unmanned aerial vehicle using a smart device are summarized as follows. The volume key of the smart device is defined to synchronously adjust the flight height of the unmanned plane, and the unmanned plane communicates with the smart device through 3G, 4G, 5G, Bluetooth, or wifi. The volume key of the smart device is defined to synchronously adjust the flight height of the unmanned plane, so that the height of the unmanned plane is controlled conveniently.

### BRIEF DESCRIPTION OF THE DRAWINGS

FIG. 1 is a schematic diagram of an unmanned aerial vehicle according to an embodiment.

### DETAILED DESCRIPTION OF THE EMBODIMENTS

Detailed description will be given below in conjunction with accompanying drawings.

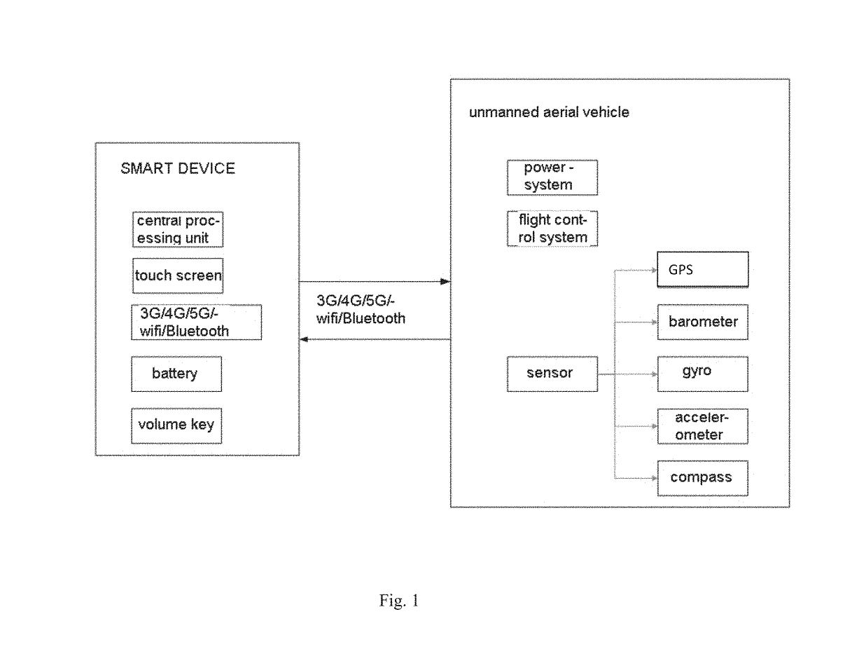

As shown in FIG. 1, the invention provides a method for controlling unmanned aerial vehicle using a smart device, the unmanned aerial vehicle comprising at least a smart device and an unmanned plane, the smart device operating to control the flight of the unmanned plane via wireless communication signal, the smart device comprising in-built central processing unit, touch screen, wireless communication system, battery, and volume key, the wireless communication system comprises 3G, 4G, 5G, Bluetooth, and wifi communications, and an application for controlling the unmanned plane being installed in the smart device; the unmanned plane comprising a power system, a flight control system, and a sensor; an operation interface of the application operating to display information returned from the unmanned plane via communication link; through inputting operational commands, control signals being transmitted to the unmanned plane via the communication link, the operational commands sent to the unmanned plane comprising flight in fixed height, automatic flight, manual flight, direction control of the unmanned plane, height adjustment, one-key take off, photographing and video; the application comprising a virtual accelerator and yawer, and a virtual rolling and pitching rocker; the smart device adapted to display shot images and geographical images shot by the unmanned plane, to display flight parameters and sensor information of the unmanned plane; the displayed information comprising compass information, wifi signals, GPS signal, battery indicator, flight time, flight speed, flight height, and flight distance; the volume key of the smart device operating to synchronously adjust the flight height of the unmanned plane, turning up the volume meaning increasing the height, turning down the volume meaning decreasing the height. The unmanned plane includes a power system, a flight control system, and a sensor. The sensor comprises GPS, barometer, gyro, accelerometer, and compass.

The method for controlling unmanned aerial vehicle comprises: 1) using the wireless communication system of the smart device to communicate with the unmanned plane; 2) using the application installed in the smart device to manipulate the unmanned plane; 3) using the wireless communication system to control the transmission of the commands of the unmanned plane, and to send the flight parameters of the unmanned plane back to the smart device; and 4) defining the volume key of the smart device to synchronously adjust the flight height of the unmanned plane. The volume key of the smart device is defined to synchronously adjust the flight height of the unmanned plane, so that the height of the unmanned plane is controlled conveniently.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method for controlling an unmanned aerial vehicle using a smart device, wherein the unmanned aerial vehicle comprises at least a smart device and an unmanned plane, wherein the smart device is configured to operate to control the flight of the unmanned plane via wireless communication signals, wherein the smart device comprises an in-built central processing unit, a touch screen, a wireless communication system, a battery, a volume key, and an application for controlling the unmanned plane being installed with the smart device; wherein the unmanned plane comprises a power system, a flight control system, and a sensor; wherein an operation interface of the application is configured to display information returned from the unmanned plane via communication link, and control signals being transmitted to the unmanned plane via the communication link through inputting operational commands; wherein the operational commands sent to the unmanned plane comprises flight in fixed height, automatic flight, manual flight, direction control of the unmanned plane, height adjustment, one-key take off, photographing and video; wherein the application comprises a virtual accelerator and yawer, and a virtual rolling and pitching rocker; wherein the smart device is configured to display shot images and geographical images taken by the unmanned plane, flight parameters and sensor information of the unmanned plane; wherein the displayed information comprises compass inform ad on, wifi/Bluetooth/3G/4G/5G signals, GPS signals, battery indicator, flight time, flight speed, flight height, and flight distance; wherein the volume key of the smart device is configured to operate to synchronously adjust the flight height of the unmanned plane, increasing the height by turning up the volume, decreasing the height by turning down the volume;
wherein the method for controlling the unmanned aerial vehicle comprises: 1) using the wireless communication system of the smart device to communicate with the unmanned plane; 2) using the application installed in the smart device to manipulate the unmanned plane; 3) using the wireless communication system to control transmission of the commands of the unmanned plane, and to send the flight parameters of the unmanned plane back to the smart device; and 4) defining the volume key of the smart device to synchronously adjust the flight height of the unmanned plane.

2. The method of claim 1, wherein the sensor comprises a GPS, a barometer, a gyro, an accelerometer, and a compass.

3. The method of claim 1, wherein the wireless communication system comprises 3G, 4G, 5G, Bluetooth, and wifi communications.
